(19) United States
(12) Patent Application Publication
(10) Pub. No.: US 2015/0079460 A1
(43) Pub. Date: Mar. 19, 2015

(54) RECHARGEABLE BATTERY

(71) Applicant: SAMSUNG SDI CO., LTD., Yongin-si (KR)

(72) Inventors: Sang-Won BYUN, Yongin-si (KR); Young-Sik MOON, Yongin-si (KR); Hong-Hyeon LEE, Yongin-si (KR); Joong-Heon KIM, Yongin-si (KR); Byung-Kyu AHN, Yongin-si (KR)

(73) Assignee: SAMSUNG SDI CO., LTD., Yongin-si (KR)

(21) Appl. No.: 14/289,691

(22) Filed: May 29, 2014

(30) Foreign Application Priority Data
Sep. 16, 2013 (KR) 10-2013-0111292

(51) Int. Cl. H01M 2/08

(52) U.S. Cl. CPC H01M 2/08
USPC 429/178

(57) ABSTRACT

A rechargeable battery includes an electrode assembly to perform charging and discharging, an electrode terminal electrically connected to the electrode assembly, a case that receives the electrode assembly, a cap plate coupled to the case, and an insulation tape including a portion separated into at least two pieces and attached to an external surface of the case, edge portions of the case overlapping at least three sheets of the insulation tape attached to the external surface of the case.

### CROSS-REFERENCE TO RELATED APPLICATION

Korean Patent Application No. 10-2013-0111292, filed on Sep. 16, 2013, in the Korean Intellectual Property Office, and entitled: “Rechargeable Battery,” is incorporated by reference herein in its entirety.

### BACKGROUND

1. Field

Embodiments relate generally to a rechargeable battery.

2. Description of the Related Art

A rechargeable battery is a battery that can be repeatedly charged and discharged, unlike a primary battery. A small rechargeable battery is used as a power supply for small electronic devices such as cellular phones, notebook computers, and camcorders, while a medium or large rechargeable battery is used as a power supply for driving motors in hybrid vehicles and the like.

A large capacity high power rechargeable battery using a non-aqueous electrolyte with high energy density has been recently developed. The large capacity high power rechargeable battery is constructed with a high power battery module having a plurality of rechargeable cells coupled to each other in series or in parallel. The high power battery module may be used in electric vehicles requiring high power. The rechargeable battery may have a cylindrical shape, a square shape, or a pouch shape.

### SUMMARY

Embodiments are directed to a rechargeable battery including an electrode assembly to perform charging and discharging, an electrode terminal electrically connected to the electrode assembly, a case that receives the electrode assembly, a cap plate coupled to the case, and an insulation tape including a portion separated into at least two pieces and attached to an external surface of the case, edge portions of the case being overlapped with at least three sheets of the insulation tape attached to the external surface of the case.

The insulation tape may include a first tape attached to a surface of the case along a circumference of the case, a second tape attached to overlap a part of the first tape at an edge of one side of the first tape, a third tape attached to overlap a part of the first tape at an edge of another side of the first tape facing the edge of the one side of the first tape, and a fourth tape attached along the circumference of the case and covering the second tape and the third tape.

The second tape may overlap a part of the first tape along an edge portion of the case at a position where the cap plate of the case is located.

The second tape may be bent along one of the edge portions of the case. An edge of one side of the second tape may extend in a surface direction of the cap plate. An edge of another side of the second tape may extend to cover a part of the surface of the case.

The third tape may overlap a part of the first tape along an edge of the first tape at a bottom side of the case.

The third tape may be bent along another of the edge portions of the case. An edge of one side of the third tape may extend to cover a bottom side of the case. An edge of another side of the third tape may extend toward a center of the case in a length direction of the case.

The fourth tape may cover a same area as the first tape.

The fourth tape may be attached to an external side of the case to overlap an overlapped part of edges of the first tape, an edge of the second tape, and an edge of the third tape.

The insulation tape may overlap a corner of a bottom side of the case and a corner of the case where the cap plate is coupled to the case, with at least three sheets of the insulating tape.

The insulation tape may include a base tape attached along a corner at a position where the cap plate is coupled to the case and a corner at a bottom side of the case, an edge of the base tape including multiple bends such that the edge of the base tape overlaps itself with at least twice, and a cover tape covering the base tape, the cover tape being attached along a circumference of the case.

A bent groove may be formed in an end of the edge of the base tape.

The cover tape may be attached to the circumference of the case such that an edge of the cover tape is inserted into the bent groove.

The base tape may include a top base tape attached along a corner of the case at a position where the cap plate is coupled to the case, and a bottom base tape attached along a corner at the bottom side of the case.

The top base tape may be bent along a corner of the case. An edge of one side of the top base tape may be extended in a surface direction of the cap plate. An edge of another side of the top base tape may be extended to cover a part of a surface of the case.

The bottom base tape may be bent along a corner at a bottom side of the case. An edge of one side of the bottom base tape may extend to cover the bottom side of the case. An edge of another side of the bottom base tape may extend toward a lateral side of the case.

### BRIEF DESCRIPTION OF THE DRAWINGS

Features will become apparent to those of skill in the art by describing in detail exemplary embodiments with reference to the attached drawings in which:

FIG. 1 illustrates a perspective view of a rechargeable battery according to an exemplary embodiment.

FIG. 2 illustrates a cross-sectional view with respect to a line II-II of FIG. 1.

FIG. 3 illustrates a cross-sectional view with respect to a line III-III of FIG. 1.

FIG. 4 illustrates a perspective view of a state in which a fourth tape is separated while first to third tapes are attached to a case.

FIG. 5 illustrates a perspective view of a state in which second to fourth tapes are separated while a first tape is attached to wrap a circumference of the case.

FIG. 6 illustrates a cross-sectional view of a rechargeable battery according to another exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

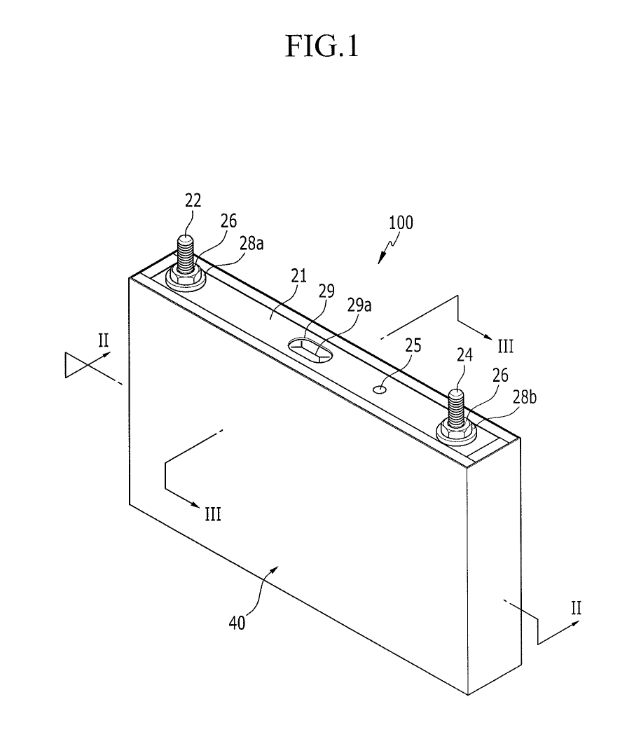

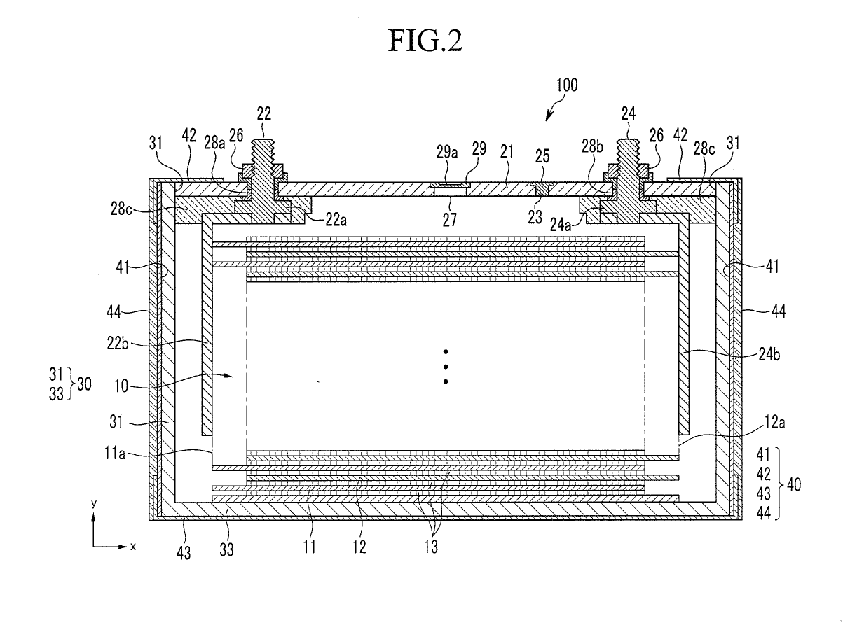

FIG. 1 illustrates a perspective view of a rechargeable battery according to an exemplary embodiment, and FIG. 2 illustrates a cross-sectional view with respect to a line II-II of FIG. 1.

As shown in FIG. 1 and FIG. 2, the rechargeable battery 100 may include an electrode assembly 10 to perform charging and discharging, terminals 22 and 24 electrically connected to the electrode assembly 10, a case 30 that receives the electrode assembly 10 while the terminals 22 and 24 are drawn out of the case, and an insulation tape 40 attached to an external surface of the case 30. A cap plate 21 may be installed in an opening 31 of the case 30, and the terminals 22 and 24 including a positive electrode terminal 22 and a negative terminal 24 may be installed on the cap plate 21.

A positive electrode 11 and a negative electrode 12 each include a coated region that is generated by coating an active material on a current collector made of a thin-plate metal foil, and respective uncoated regions 11a and 12a on which the active material is not coated. The positive electrode uncoated region 11a may be formed at a first end in a length direction of the positive electrode 11, and the negative uncoated region 12a may be formed at a second end in a length direction of the negative electrode 12.

The positive electrode 11 and the negative electrode 12 may be stacked with a separator 13 that is an insulator therebetween, may be spirally-wound by using a spirally wound roll, and may form a jellyroll-type electrode roll 10. The electrode roll 10 may be pressurized by a press and may be formed to be flat so that the electrode roll 10 may be installed in the case 30.

The case 30 may be substantially formed to be a cuboid, and the opening 31 may be formed in one side thereof.

The cap plate 21 may be formed as a thin plate and may be coupled to and installed at the opening 31 of the case 30. A seal stopper 25 may be installed in an electrolyte injection opening 23 in the cap plate 21. A vent plate 29 in which a notch 29a is formed may be installed in a vent hole 27 in the cap plate 21 so as be opened at a predetermined pressure.

The positive electrode terminal 22 and the negative electrode terminal 24 may be installed to pass through the cap plate 21. Flanges 22a and 24a supported below the cap plate 21 may be formed at the bottom of the positive electrode terminal 22 and the negative electrode terminal 24. An external circumferential surface of an upper column of the positive electrode terminal 22 and the negative electrode terminal 24 that protrudes outside the cap plate 21 may be screw-processed. In addition, nuts 26 supporting the positive electrode terminal 22 and the negative electrode terminal 24 at their tops may be fastened to the positive electrode terminal 22 and the negative electrode terminal 24.

A gasket 28a may be installed between the positive electrode terminal 22 and the cap plate 21. Further, a gasket 28b may be installed between the negative terminal 24 and the cap plate 21 to seal a space between the terminals 22 and 24 and the cap plate 21.

The positive electrode terminal 22 may be electrically connected to the positive electrode 11 through a positive electrode lead tab 22b as a medium, and the negative terminal 24 may be electrically connected to the negative electrode 12 through a negative electrode lead tab 24b as a medium. An insulation member 28c may be inserted between the positive electrode terminal 22 and the positive electrode lead tab 22b and between the negative terminal 24 and the negative electrode lead tab 24b.

The insulation tape 40 may be attached to an external surface of the case 30.

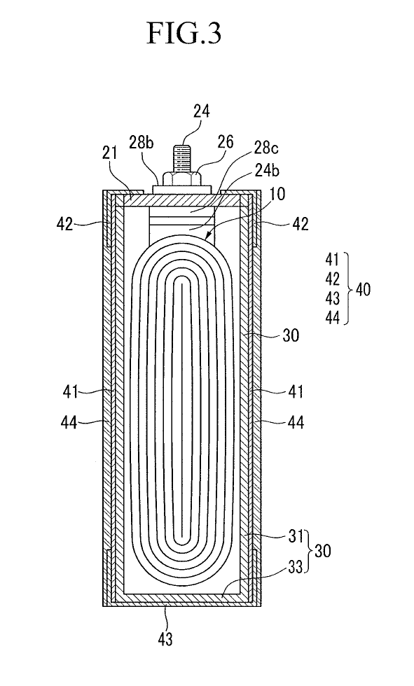

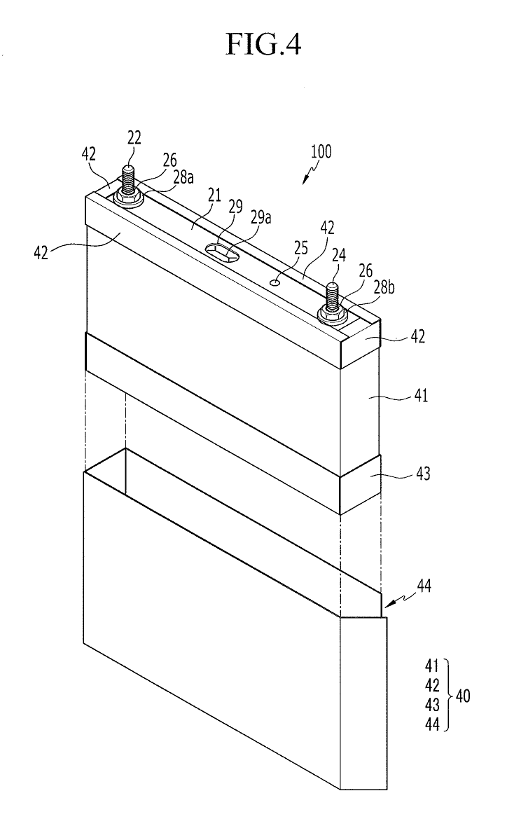

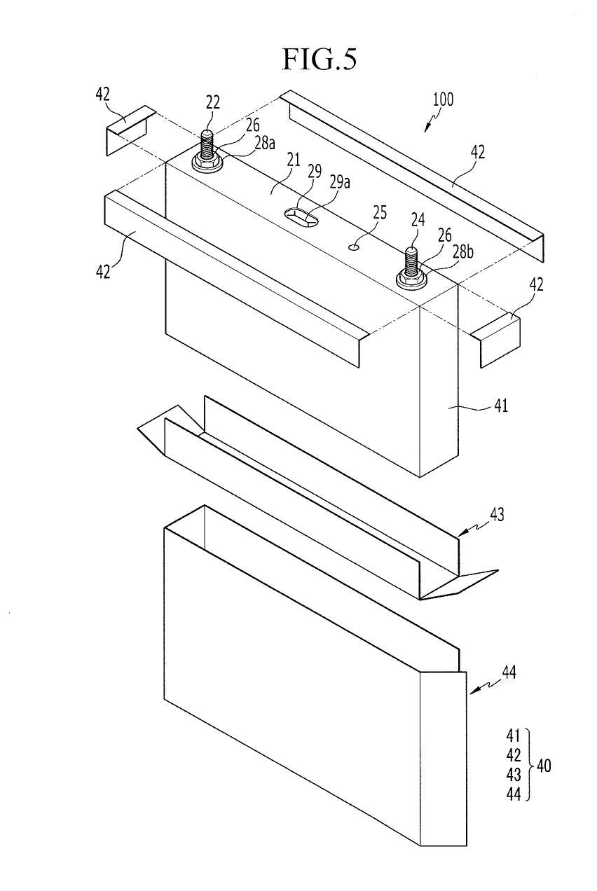

FIG. 3 illustrates a cross-sectional view with respect to a line of FIG. 1, FIG. 4 illustrates a perspective view of a state in which a fourth tape is separated while first to third tapes are attached to a case, and FIG. 5 illustrates a perspective view of a state in which second to fourth tapes are separated while a first tape is attached to wrap a circumference of the case.

As shown in FIG. 3 to FIG. 5, the insulation tape 40 may be attached as at least two divided parts to the external surface of the case 30. The insulation tape 40 may include a first tape 41 attached along a circumference of the case 30, a second tape 42 attached to a side at which the terminals 22 and 24 protrude from the case 30, a third tape 43 attached to a bottom side 33 of the case 30, and a fourth tape 44 that covers the second tape 42 and the third tape 43.

The first tape 41 may be attached to insulate the external surface of the case 30 in a first manner. The first tape 41 may be attached along the circumference of the case 30 between a part at which the terminals 22 and 24 protrude from the case 30 and the bottom side 33 of the case 30. By the attachment of the first tape 41, the cap plate 21 and the external surface of the bottom side 33 of the case 30 may not be insulated but may be exposed. The second tape 42 may be attached to the first tape 41 while the second tape 42 may partially overlap the first tape 41.

The second tape 42 may be attached to overlap the first tape 41 at a corner of one side of the case 30. A center portion of the second tape 42 in a length direction may be bent and attached along the corner of the one side of the case 30. An edge of one side of the second tape 42 may extend in a surface direction of the cap plate 21, and an edge of another side of the second tape 42 may extend to cover the surface of the case 30. The second tape 42 may be attached to partially cover the cap plate 21 and the case 30 and thus may be attached to insulate the corner of the case 30 at the part where the cap plate 21 is installed.

When the case 30 is formed as a rectangle, multiple second tapes 42 may be attached to the position where the cap plate 21 is installed while varying an attached length. For example, the second tape 42 may be attached such that a part of the second tape 42 that is attached to the corner that corresponds to a long side of the case 30 may be longer than a part of the second tape 42 that is attached to a corner that corresponds to a short side of the case 30. The second tape 42 may be attached to an external side of the first tape 41 such that the second tape 42 may partially overlap the external side of the first tape 41, thereby further insulating the corner of the case 30 at the position where the cap plate 21 is installed.

The third tape 43 may be attached to overlap the first tape 41 at the corner of the bottom side of the case 30. In detail, a center portion of the third tape 43 in the length direction may be bent and attached along the corner of the bottom side of the case 30. An edge of one side of the second tape 42 may extend in the surface direction of the cap plate 21. An edge of another side of the second tape 42 may extend to partially cover the bottom side of the case 30. The third tape 43 may be attached to insulate the corner of the case 30 at the bottom side position. The third tape 43 may include the same material as the first tape 41 and the second tape 42.

The fourth tape 44 covers the entire area of the first tape 41, the second tape 42, and the third tape 43 with the same area as the first tape 41. The fourth tape 41 may be attached along the circumference of the case 30. While the first tape 41, the second tape 42, and the third tape 43 may insulate a part of the case 30 with double layers, the fourth tape 44 may be attached to cover the first tape 41, the second tape 42, and the third tape 43 to partially insulate the case 30 with three layers. The fourth tape 44 allows multiple insulation performance at the separated parts of the edge of the first tape 41, the second tape 42, and the third tape 43 to thus prevent permeation of a foreign material such as moisture into the case 30 and prevent generation of damage to the rechargeable battery 100 caused by the foreign material.

The insulation tape 40 may be attached at the edge of the case 30 while overlapping the case 30 with at least three sheets, such that external moisture may not pass through the insulation tape 40 to be provided into the case 30. Accordingly, generation of a short circuit and corrosion of the rechargeable battery 100 may be prevented, and durability and stability of the rechargeable battery may be improved.

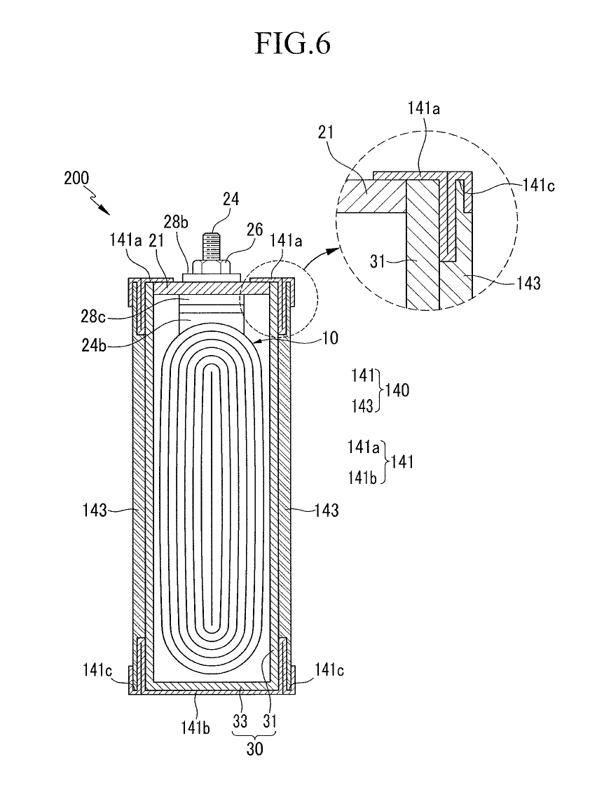

FIG. 6 illustrates a cross-sectional view of a rechargeable battery according to another exemplary embodiment. The same reference numerals used in FIG. 1 to FIG. 5 indicate the same members with the same functions in FIG. 6. A detailed description with regard to features indicated by the same reference numerals will not be repeated.

As shown in FIG. 6, an insulation tape 140 of a rechargeable battery 200 according to this exemplary embodiment may include a base tape 141 attached to an external surface of a case 30, and a cover tape 143 that covers the base tape 141. The base tape 141 may include a top base tape 141a attached to cover an edge of a top where the cap plate 21 of the case 30 is installed, and a bottom base tape 141b attached to cover an edge on a bottom side of the case 30.

At least two top base tapes 141a may be attached to the top of the case 30 and may insulate the top of the case 30. One side of the top base tape 141a may be extended to cover a part of the cap plate 21 and another side thereof may extend to cover a part of the case 30. A bent groove 141c overlapping with at least two sheets may be formed at an edge connected to the cover tape 143 in the top tape 141a. As described, the edge of the top base tape 141a may overlap with at least two sheets in order to prevent permeation of a foreign material such as moisture into the case 30.

The bottom base tape 141b may be attached to insulate the bottom side of the case 30. The bottom base tape 141b may be bent along the edge of the bottom side of the case 30. One side of the bottom base tape 141b may extend in a lateral direction of the case 30, and another side of the bottom base tape 141b may be formed to cover the bottom side of the case 30. The bent groove 141c that is bent to overlap with at least two sheets may be formed at the part of the bottom base tape 141b that is connected to the cover tape 143, for example, an edge of the bottom base tape 141b extending in the lateral direction of the case 30. The edge of the bottom base tape 141b may overlap with at least two sheets. Accordingly, permeation of a foreign material such as moisture into the case 30 may be prevented.

The cover tape 143 may be attached to the external surface of the case 30. Respective sides of the edge of the cover tape 143 may be inserted into the bent groove 141c of the top base tape 141a and the bent groove 141c of the bottom base tape 141b. The cover tape 143 may be attached to cover the top tape 141a and the bottom tape 141b while being inserted into the bent grooves 141c of the top tape 141a and the bottom tape 141b, thereby preventing permeation of a foreign material such as moisture into the case 30 and further improving durability of the rechargeable battery 100.

By way of summation and review, a square rechargeable battery includes an electrode group (i.e., an electrode assembly) including an anode and a cathode positioned with a separator interposed therebetween, a case with a space for housing the electrode group, and a cap plate for sealing the case and having a terminal hole into which an electrode terminal is inserted, the electrode terminal being electrically connected with the electrode group and inserted into the terminal hole so as to be outwardly protruded from the case.

An insulation tape is attached to an external part of the rechargeable battery to prevent a foreign material such as moisture from being permeated into the case. However, the insulation tape is generally attached to a circumference of the rechargeable battery as a single insulation tape. Therefore, foreign materials such as moisture may be easily permeate into the case at a boundary of the case and the insulation tape. The durability of the insulating tape may be worsened by corrosion of the rechargeable battery.

Embodiments provide a rechargeable battery in which permeation of a foreign material such as moisture is prevented by attaching at least two sheets of insulation tape to an external surface of a case. Thereby, durability of the rechargeable battery may be improved.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A rechargeable battery, comprising:
an electrode assembly to perform charging and discharging;
an electrode terminal electrically connected to the electrode assembly;
a case that receives the electrode assembly;
a cap plate coupled to the case; and
an insulation tape including a portion separated into at least two pieces and attached to an external surface of the case, edge portions of the case overlapping with at least three sheets of the insulation tape attached to the external surface of the case.

2. The rechargeable battery as claimed in claim 1, wherein
the insulation tape includes:
a first tape attached to a surface of the case along a circumference of the case;
a second tape attached to overlap a part of the first tape at an edge of one side of the first tape;
a third tape attached to overlap a part of the first tape at an edge of another side of the first tape facing the edge of the one side of the first tape; and
a fourth tape attached along the circumference of the case and covering the second tape and the third tape.

3. The rechargeable battery as claimed in claim 2, wherein
the second tape overlaps a part of the first tape along an edge portion of the case at a position where the cap plate of the case is located.

4. The rechargeable battery as claimed in claim 3, wherein
the second tape is bent along one of the edge portions of the case,
an edge of one side of the second tape extends in a surface direction of the cap plate, and
an edge of another side of the second tape extends to cover a part of the surface of the case.

5. The rechargeable battery as claimed in claim 2, wherein
the third tape overlaps a part of the first tape along an edge of the first tape at a bottom side of the case.

6. The rechargeable battery as claimed in claim 5, wherein
the third tape is bent along another of the edge portions of the case,
an edge of one side of the third tape extends to cover a bottom side of the case, and
an edge of another side of the third tape extends toward a center of the case in a length direction of the case.

7. The rechargeable battery as claimed in claim 2, wherein
the fourth tape covers a same area as the first tape.

8. The rechargeable battery as claimed in claim 7, wherein
the fourth tape is attached to an external side of the case to overlap an overlapping part of edges of the first tape, an edge of the second tape, and an edge of the third tape.

9. The rechargeable battery as claimed in claim 1, wherein
the insulation tape overlaps a corner of a bottom side of the case and a corner of the case where the cap plate is coupled to the case, with at least three sheets of the insulating tape.

10. The rechargeable battery as claimed in claim 1, wherein
the insulation tape includes:
a base tape attached along a corner at a position where the cap plate is coupled to the case and a corner at a bottom side of the case, an edge of the base tape including multiple bends such that the edge of the base tape overlaps itself with at least twice; and
a cover tape covering the base tape, the cover tape being attached along a circumference of the case.

11. The rechargeable battery as claimed in claim 10, wherein
a bent groove is formed in an end of the edge of the base tape.

12. The rechargeable battery as claimed in claim 11, wherein
the cover tape is attached to the circumference of the case such that an edge of the cover tape is inserted into the bent groove.

13. The rechargeable battery as claimed in claim 10, wherein
the base tape includes:
a top base tape attached along a corner of the case at a position where the cap plate is coupled to the case; and
a bottom base tape attached along a corner at the bottom side of the case.

14. The rechargeable battery as claimed in claim 13, wherein
the top base tape is bent along a corner of the case,
an edge of one side of the top base tape extends in a surface direction of the cap plate, and
an edge of another side of the top base tape extends to cover a part of a surface of the case.

15. The rechargeable battery as claimed in claim 13, wherein
the bottom base tape is bent along a corner at a bottom side of the case,
an edge of one side of the bottom base tape extends to cover the bottom side of the case, and
an edge of another side of the bottom base tape extends toward a lateral side of the case.
